(19) United States
(12) Patent Application Publication
(10) Pub. No.: US 2016/0332827 A1
(43) Pub. Date: Nov. 17, 2016

(54) Foldable Ramp Assembly

(71) Applicant: Heidi Leibowitz, Hoboken, NJ (US)

(72) Inventor: Heidi Leibowitz, Hoboken, NJ (US)

(21) Appl. No.: 14/711,974

(22) Filed: May 14, 2015

(51) Int. Cl. B65G 69/30; E01D 15/12

(52) U.S. Cl. CPC B65G 69/30; E01D 15/124

(57) ABSTRACT

A foldable ramp assembly includes a ramp has a first section, a medial section and a second section. The ramp has a first half and a second half. A pair of first hinges is provided and each of the first hinges is attached to the ramp such that each of the first section and the second section is hingedly coupled to the medial section. A second hinge is attached to the ramp such that the first half is hingedly coupled to the second half. The ramp is positionable in a deployed position wherein the ramp may be positioned on a staircase thereby facilitating a cart to be rolled up and down on the ramp. The ramp is positionable in a stored position wherein the ramp forms a case. A pair of handles is each of the handles is attached to the ramp wherein each of the handles may be gripped.

### BACKGROUND OF THE DISCLOSURE

### Field of the Disclosure

The disclosure relates to ramp devices and more particularly pertains to a new ramp device for facilitating an object to be moved up or down a staircase.

### SUMMARY OF THE DISCLOSURE

An embodiment of the disclosure meets the needs presented above by generally comprising a ramp has a first section, a medial section and a second section. The ramp has a first half and a second half. A pair of first hinges is provided and each of the first hinges is attached to the ramp such that each of the first section and the second section is hingedly coupled to the medial section. A second hinge is attached to the ramp such that the first half is hingedly coupled to the second half. The ramp is positionable in a deployed position wherein the ramp may be positioned on a staircase thereby facilitating a cart to be rolled up and down on the ramp. The ramp is positionable in a stored position wherein the ramp forms a case. A pair of handles is each of the handles is attached to the ramp wherein each of the handles may be gripped.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a foldable ramp assembly in a deployed position according to an embodiment of the disclosure.

FIG. 2 is a perspective view of an embodiment of the disclosure in a stored position.

FIG. 3 is a front view of an embodiment of the disclosure.

FIG. 4 is a back view of an embodiment of the disclosure.

FIG. 5 is a perspective in-use view of an embodiment of the disclosure.

### DESCRIPTION OF THE PREFERRED EMBODIMENT

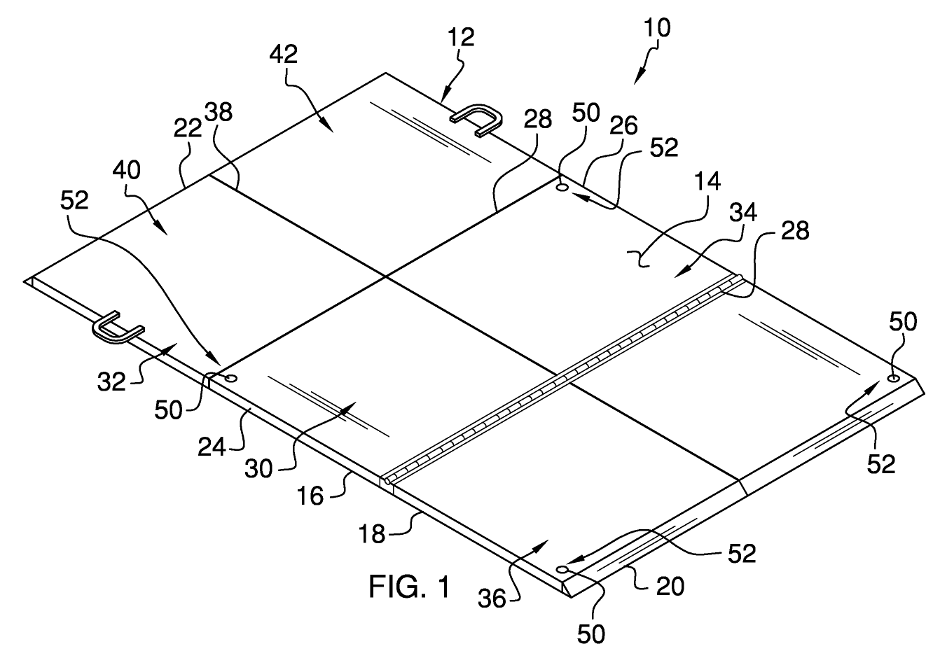

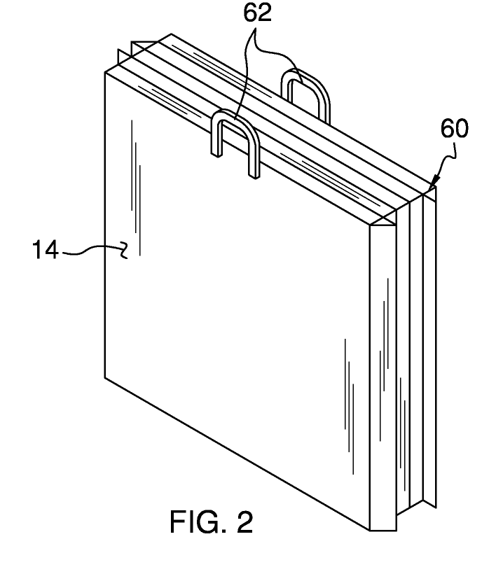

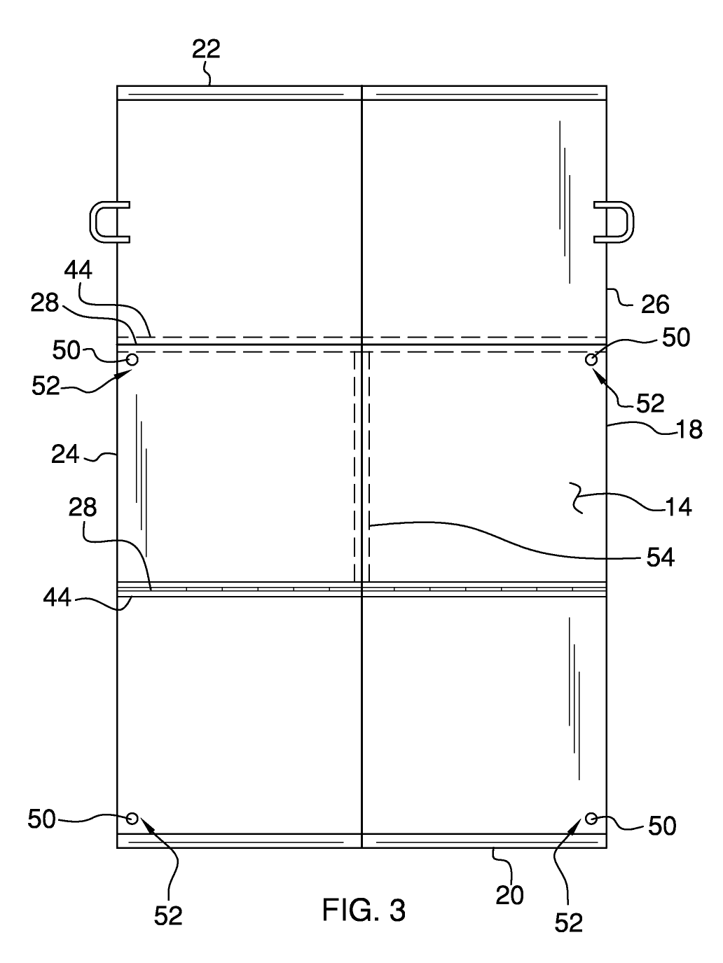

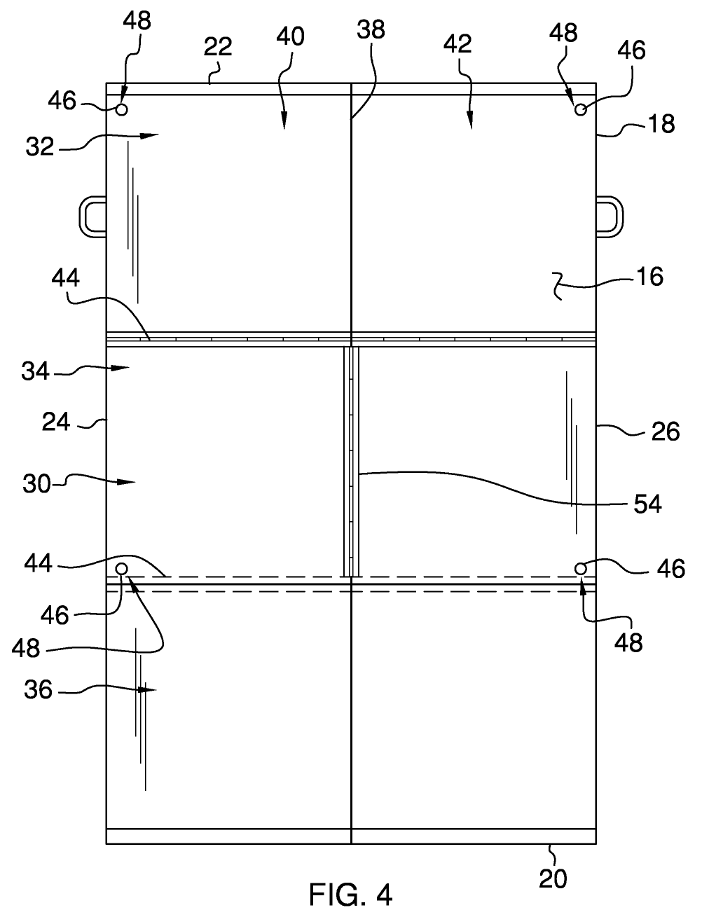

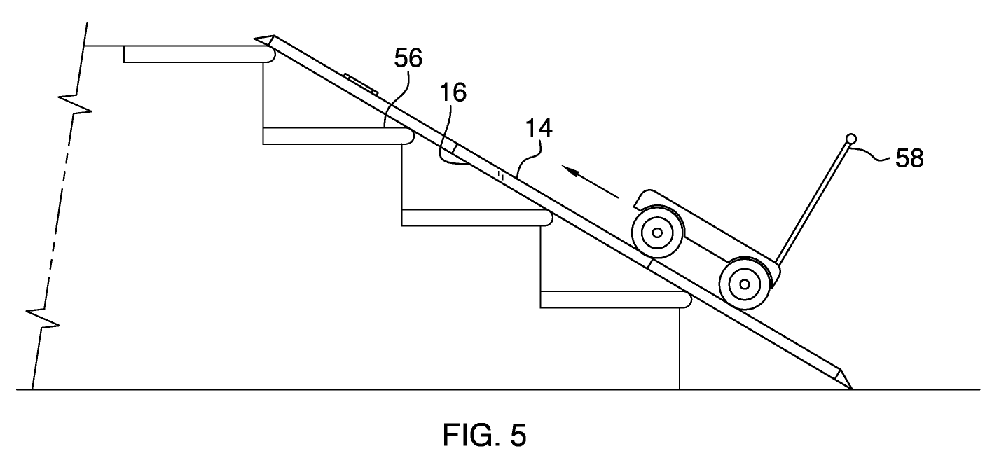

With reference now to the drawings, and in particular to FIGS. 1 through 5 thereof, a new ramp device embodying the principles and concepts of an embodiment of the disclosure and generally designated by the reference numeral 10 will be described.

As best illustrated in FIGS. 1 through 5, the foldable ramp assembly 10 generally comprises a ramp 12 that has a front surface 14, a rear surface 16 and a peripheral edge 18 extending between the front surface 14 and the rear surface 16. The peripheral edge 18 has a front side 20, a back side 22, a first lateral side 24 and a second lateral side 26. The ramp 12 may have a length ranging between approximately 4 feet and 6 feet and a width ranging between approximately 2 feet and 3 feet.

The ramp 12 has a pair of first cuts 28 and each of the first cuts 28 extends through the front surface 14 and the rear surface 16. Each of the first cuts 28 extends between the first lateral side 24 and the second lateral side 26. Each of the first cuts 28 is spaced apart from a center 30 of the ramp 12 to define a first section 32, a medial section 34 and a second section 36 of the ramp 12. The ramp 12 has a second cut 38 and the second cut 38 extends through the front surface 14 and the rear surface 16. The second cut 38 extends between the front side 20 and the back side 22 to define a first half 40 and a second half 42 of the ramp 12. Each of the front side 20 and the back side 22 slopes downwardly between the front surface 14 and the rear surface 16.

A pair of first hinges 44 is provided and each of the first hinges 44 is attached to the ramp 12. One of the first hinges 44 is positioned on the rear surface 16 and one of the first hinges 44 is positioned on the front surface 14. Each of the first hinges 44 is aligned with an associated one of the first cuts 28 such that each of the first section 32 and the second section 36 is hingedly coupled to the medial section 34. Each of the first hinges 44 extends between the first lateral side 24 and the second lateral side 26 and each of the first hinges 44 is split along the second cut 38.

Each of the first section 32 and the second section 36 is positionable in a deployed position having the front surface 14 corresponding to each of the first section 32 and the second section 36 being planar with the front surface 14 corresponding to the medial section 34. The first section 32 is positionable in a stored position having the rear surface 16 corresponding to the first section 32 abutting the rear surface 16 corresponding to the medial section 34. The second section 36 is positionable in a stored position having the front surface 14 corresponding to the second section 36 abutting the front surface 14 corresponding to the medial section 34.

A plurality of first couplers 46 is provided and each of the first couplers 46 is attached to the ramp 12. Each of the first couplers 46 is positioned on the rear surface 16 and the first couplers 46 are arranged into opposable pairs 48 of the first couplers 46. One of the opposable pairs 48 of the first couplers 46 is positioned adjacent to the first lateral side 24 and one of the opposable pairs 48 of the first couplers 46 is positioned adjacent to the second lateral side 26. Each of the opposable pairs 48 of the first couplers 46 is matable when the first section 32 is positioned in the stored position such that the opposable pairs 48 of first couplers 46 magnetically engage each other. Thus, the first section 32 is retained in the stored position.

A plurality of second couplers 50 is provided and each of the second couplers 50 is attached to the ramp 12. Each of the second couplers 50 is positioned on the front surface 14 and the second couplers 50 are arranged into opposable pairs 52 of the second couplers 50. One of the opposable pairs 52 of the second couplers 50 is positioned adjacent to the first lateral side 24 and one of the opposable pairs 52 of the second couplers 50 is positioned adjacent to the second lateral side 26. Each of the opposable pairs 52 of the second couplers 50 is matable when the second section 34 is positioned in the stored position such that the opposable pairs 52 of second couplers 50 magnetically engage each other. Thus, the second section 34 is retained in the stored position.

A second hinge 54 is attached to the ramp 12. The second hinge 54 is positioned on the rear surface 16 and the second hinge 54 is aligned with and is coextensive with the first cut 28 corresponding to the medial section 34. Thus, the first half 40 is hingedly coupled to the second half 42. Each of the first half 40 and the second half 42 are positionable in a deployed position when the first section 32 and the second section 36 are positioned in the deployed position having the rear surface 16 of each of the first half 40 and the second half 42 being co-planar. Thus, the rear surface 16 may be positioned on a staircase 56 thereby facilitating a cart 58 or other object to be moved up and down along the front surface 14.

The second hinge 54 may comprise a dual hinge or the like such that the second hinge 54 is selectively expandable thereby allowing the first half 40 to be spaced from the second half 42. Each of the first half 40 and the second half 42 is positionable in a stored position having the rear surface 16 corresponding to the first half 40 abutting the rear surface 16 corresponding to the second half 42 when each of the first section 32 and the second section 36 are positioned in the stored position. Thus, the ramp 12 forms a case 60.

A pair of handles 62 is provided and each of the handles 62 is attached to the ramp 12. Each of the handles 62 is positioned on the front surface 14 and each of the handles 62 is positioned on the first section 32. One of the handles 62 is positioned to extend outwardly from the first lateral side 24 and one of the handles 62 is positioned to extend outwardly from the second lateral side 26. The handles 62 are aligned with each other when the ramp 12 forms the case 60. Thus, each of the handles 62 may be gripped when the ramp 12 forms the case 60 thereby facilitating the ramp 12 to be carried.

In use, the first half 40 and the second half 42 are positioned in the deployed position and the first section 32 and the second section 36 are positioned on the deployed position. The ramp 12 is positioned on the staircase 56 having the rear surface 16 of the ramp 12 abutting the stair case 56. The cart 58 or other object is moved up or down along the front surface 14 of the ramp 12. The first section 32 and the second section 34 are positioned in the stored position thereby facilitating the first couplers 46 to retain the first section 32 and the second section 34 in the deployed position. The first half 40 and the second half 42 are positioned in the stored position thereby facilitating the second couplers 50 to retain the first half 40 and the second half 42 in the stored position. The ramp 12 forms the case 60 and the handles 62 are gripped thereby facilitating the case 60 to be carried.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A foldable ramp assembly configured to be deployed on a flight of stairs, said assembly comprising:
a ramp having a first section, a medial section and a second section, said ramp having a first half and a second half;
a pair of first hinges, each of said first hinges being attached to said ramp such that each of said first section and said second section is hingedly coupled to said medial section;
a second hinge being attached to said ramp such that said first half is hingedly coupled to said second half, said ramp being positionable in a deployed position wherein said ramp is configured to be positioned on a staircase thereby facilitating a cart to be rolled up and down on said ramp, said ramp being positionable in a stored position wherein said ramp forms a case; and
a pair of handles, each of said handles being attached to said ramp wherein each of said handles are configured to be gripped.

2. The assembly according to claim 1, wherein said ramp has a front surface, a rear surface and a peripheral edge extending between said front surface and said rear surface, said peripheral edge having a front side, a back side, a first lateral side and a second lateral side, said ramp having a pair of first cuts, each of said first cuts extending through said front surface and said rear surface, each of said first cuts extending between said first lateral side and said second lateral side, each of said first cuts being spaced apart from a center of said ramp to define said first section, said medial section and said second section of said ramp.

3. The assembly according to claim 2, wherein said ramp has a second cut, said second cut extending through said front surface and said rear surface, said second cut extending between said front side and said back side to define said first half and said second half of said ramp, each of said front side and said back side sloping downwardly between said front surface and said rear surface.

4. The assembly according to claim 1, wherein:
said ramp has a front surface, a pair of first cuts, a first lateral side and a second lateral side; and
one of said first hinges is positioned on said rear surface, one of said first hinges being positioned on said front surface, each of said first hinges being aligned with an associated one of said first cuts such that each of said first section and said second section is hingedly coupled to said medial section, each of said first hinges extending between said first lateral side and said second lateral side, each of said first hinges being split along said second cut.

5. The assembly according to claim 4, wherein each of said first section and said second section is positionable in a deployed position having said front surface corresponding to each of said first section and said second section being planar with said front surface corresponding to said medial section.

6. The assembly according to claim 4, wherein said first section being positionable in a stored position having said rear surface corresponding to said first section abutting said rear surface corresponding to said medial section, said second section being positionable in a stored position having said front surface corresponding to said second section abutting said front surface corresponding to said medial section.

7. The assembly according to claim 1, wherein:
said ramp has a rear surface, a first lateral side and a second lateral side; and
a plurality of first couplers, each of said first couplers being attached to said ramp, each of said first couplers being positioned on said rear surface, said first couplers being arranged into opposable pairs of said first couplers, one of said opposable pairs of said first couplers being positioned adjacent to said first lateral side, one of said opposable pairs of said first couplers being positioned adjacent to said second lateral side.

8. The assembly according to claim 7, wherein:
said ramp has a first section being positionable in stored position; and
each of said opposable pairs of said first couplers being matable when said first section is positioned in said stored position such that said opposable pairs of first coupler magnetically engages each other thereby retaining said first section in said stored position.

9. The assembly according to claim 1, wherein:
said ramp has a front surface, a first lateral side and a second lateral side; and
a plurality of second couplers, each of said second couplers being attached to said ramp, each of said second couplers being positioned on said front surface, said second couplers being arranged into opposable pairs of said second couplers, one of said opposable pairs of said second couplers being positioned adjacent to said first lateral side, one of said opposable pairs of said second couplers being positioned adjacent to said second lateral side.

10. The assembly according to claim 9, wherein:
said ramp has a second section being positionable in a stored position; and
each of said opposable pairs of said second couplers being matable when said second section is positioned in said stored position such that said opposable pairs of second couplers magnetically engages each other thereby retaining said second section in said stored position.

11. The assembly according to claim 1, wherein:
said ramp has a rear surface; and
said second hinge is positioned on said rear surface, said second hinge being aligned with and being coextensive with said first cut corresponding to said medial section such that said first half is hingedly coupled to said second half.

12. The assembly according to claim 11, wherein:
said ramp has a first section and a second section, each of first section and said second section being positionable in a deployed position; and
each of said first half and said second half being positionable in a deployed position when said first section and said second section are positioned in said deployed position having said rear surface of each of said first half and said second half being co-planar.

13. The assembly according to claim 12, wherein each of said first half and said second half being positionable in a stored position having said rear surface corresponding to said first half abutting said rear surface corresponding to said second half when each of said first section and said second section are positioned in said stored position wherein said ramp forms said case.

14. The assembly according to claim 1, wherein:
said ramp has a front surface, a first section, a first lateral side and a second lateral side; and
each of said handles being positioned on said front surface, each of said handles being positioned on said first section, one of said handles being positioned to extend outwardly from said first lateral side, one of said handles being positioned to extend outwardly from said second lateral side.

15. A foldable ramp assembly configured to be deployed on a flight of stairs, said assembly comprising:
a ramp having a front surface, a rear surface and a peripheral edge extending between said front surface and said rear surface, said peripheral edge having a front side, a back side, a first lateral side and a second lateral side, said ramp having a pair of first cuts, each of said first cuts extending through said front surface and said rear surface, each of said first cuts extending between said first lateral side and said second lateral side, each of said first cuts being spaced apart from a center of said ramp to define a first section, a medial section and a second section of said ramp, said ramp having a second cut, said second cut extending through said front surface and said rear surface, said second cut extending between said front side and said back side to define a first half and a second half of said ramp, each of said front side and said back side sloping downwardly between said front surface and said rear surface;
a pair of first hinges, each of said first hinges being attached to said ramp, one of said first hinges being positioned on said rear surface, one of said first hinges being positioned on said front surface, each of said first hinges being aligned with an associated one of said first cuts such that each of said first section and said second section is hingedly coupled to said medial section, each of said first hinges extending between said first lateral side and said second lateral side, each of said first hinges being split along said second cut, each of said first section and said second section being positionable in a deployed position having said front surface corresponding to each of said first section and said second section being planar with said front surface corresponding to said medial section, said first section being positionable in a stored position having said rear surface corresponding to said first section abutting said rear surface corresponding to said medial section, said second section being positionable in a stored position having said front surface corresponding to said second section abutting said front surface corresponding to said medial section;
a plurality of first couplers, each of said first couplers being attached to said ramp, each of said first couplers being positioned on said rear surface, said first couplers being arranged into opposable pairs of said first couplers, one of said opposable pairs of said first couplers being positioned adjacent to said first lateral side, one of said opposable pairs of said first couplers being positioned adjacent to said second lateral side, each of said opposable pairs of said first couplers being matable when said first section is positioned in said stored position such that said opposable pairs of first coupler magnetically engages each other thereby retaining said first section in said stored position;
a plurality of second couplers, each of said second couplers being attached to said ramp, each of said second couplers being positioned on said front surface, said second couplers being arranged into opposable pairs of said second couplers, one of said opposable pairs of said second couplers being positioned adjacent to said first lateral side, one of said opposable pairs of said second couplers being positioned adjacent to said second lateral side, each of said opposable pairs of said second couplers being matable when said second section is positioned in said stored position such that said opposable pairs of second couplers magnetically engages each other thereby retaining said second section in said stored position;
a second hinge being attached to said ramp, said second hinge being positioned on said rear surface, said second hinge being aligned with and being coextensive with said first cut corresponding to said medial section such that said first half is hingedly coupled to said second half, each of said first half and said second half being positionable in a deployed position when said first section and said second section are positioned in said deployed position having said rear surface of each of said first half and said second half being co-planar wherein said rear surface is configured to be positioned on a staircase thereby facilitating a cart to be rolled up and down on said front surface, each of said first half and said second half being positionable in a stored position having said rear surface corresponding to said first half abutting said rear surface corresponding to said second half when each of said first section and said second section are positioned in said stored position wherein said ramp forms a case; and
a pair of handles, each of said handles being attached to said ramp, each of said handles being positioned on said front surface, each of said handles being positioned on said first section, one of said handles being positioned to extend outwardly from said first lateral side, one of said handles being positioned to extend outwardly from said second lateral side wherein each of said handles are configured to be gripped.
